(19) United States
(12) Patent Application Publication
(10) Pub. No.: US 2024/0119381 A1
(43) Pub. Date: Apr. 11, 2024

(54) EXPERTISE AND EVIDENCE BASED DECISION MAKING

(71) Applicant: International Business Machines Corporation, Armonk, NY (US)

(72) Inventors: Phillip Gregory LOPEZ, Poughkeepsie, NY (US); Jung Wook PARK, Poughkeepsie, NY (US); David C. REED, Tucson, AZ (US); Elliott PICKER, New Hamburg, NY (US)

(21) Appl. No.: 17/938,580

(22) Filed: Oct. 6, 2022

(51) Int. Cl. G06Q 10/06

(52) U.S. Cl. CPC G06Q 10/06316

(57) ABSTRACT

A method, system, and computer program product are disclosed for implementing enhanced expertise and evidence based decision making in knowledge-based applications. Expertise and evidence based decision making operations include differentiating between an average user and an expert user, and using real time feedback from expert users to update and embed expert knowledge into a predefined baseline command sequence model for a given task or problem.

### BACKGROUND

The present invention relates to the data processing field, and more specifically, to a method, system and computer program product for expertise and evidence based decision making in knowledge-based applications.

Computer knowledge-based applications can provide automated decision support for users for various application fields and contexts. Some knowledge-based applications use time of error data for diagnosing user or customer problems. However, a tremendous amount of knowledge and expertise are required to navigate and find relevant information in a system time of error data dump. Users of knowledge-based applications for various application fields struggle in diagnosing problems that are new to the user or not explored frequently.

### SUMMARY

Embodiments of the present disclosure are directed to enhanced expertise and evidence based decision making in knowledge-based applications. A non-limiting example computer-implemented method for expertise and evidence based decision-making includes differentiating between an average user and an expert user and using expert knowledge in baseline command sequences for given tasks.

One non-limiting example computer implemented method includes generating baseline command sequence models based upon commands entered and frequencies of the commands for given tasks. Command sequences entered by the expert user are monitored. When an expert entered command that diverges from the baseline command sequence model for the given task or problem is identified and the expert user is prompted to input a confidence level for the command that diverges from the baseline command sequence model and evidence supporting the diverging command. A new decision point is embedded into the baseline command sequence model using the expert user entered confidence level and supporting evidence. Recalibrating the baseline command sequence model for the given task is based upon the expert user entered confidence level and supporting evidence. Recalibrating the baseline command sequence model further comprises identifying and factoring an expertise level of the expert user, and identifying and factoring baseline command sequence model frequencies. A recommended new baseline command sequence model is generated based upon the expert user entered confidence level and supporting evidence.

Other disclosed embodiments include a computer system and computer program product for performing expertise and evidence based decision making implementing features of the above-disclosed method.

### BRIEF DESCRIPTION OF THE DRAWINGS

FIG. 1 is a block diagram of an example computer environment for use in conjunction with one or more embodiments of expertise and evidence based decision making;

FIG. 2 is a flow chart illustrating example operations of expertise and evidence based decision making logic of one or more embodiments;

FIG. 3 is a chart illustrating a command tree of commands for implementing expertise and evidence based decision making logic of FIG. 2;

FIG. 4 is a block diagram illustrating example weighted components used to calculate a recommendation or record value of expertise and evidence based decision making logic FIG. 2; and

FIG. 5 is a flow chart further illustrating and describing example operations performed by expertise and evidence based decision-making logic of FIG. 2.

### DETAILED DESCRIPTION

In accordance with features of embodiments of the disclosure, improved computing system operations for expertise and evidence based decision making comprises differentiating between average users versus an expert user and using expert knowledge to update and embed expert knowledge into baseline command sequence models. Expert knowledge includes an expert user entered confidence level, and expert user entered supporting evidence. A non-limiting method for expertise and evidence based decision making comprise monitoring command sequences entered by the expert users for a given task and identifying a command entered by the expert user that deviates from a baseline command sequence model for the given task. A new decision point for command entered by the expert user that deviates from a baseline command sequence model is embedded into the baseline command sequence model for the given task. Computing system operations to perform recalibration of the baseline command sequence model for a given task are based upon the expert entered confidence level, and expert supporting evidence. Recalibration of the baseline command sequence model further comprise factoring command sequence frequencies, and an expertise level of the expert user. Computing system operations for expertise and evidence based decision making logic provide updated baseline command sequence models for given tasks that minimize use of computer processing resources and minimize processing time for the given tasks

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

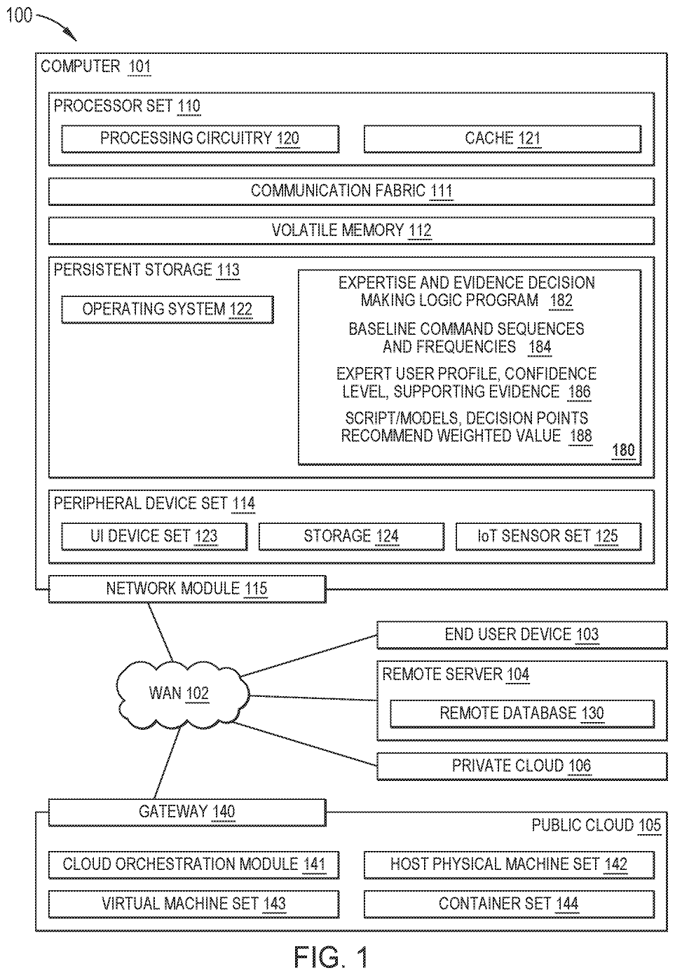

With reference now to FIG. 1, there is shown an example computing environment 100. Computing environment 100 contains an example of an environment for the execution of at least some of the computer code involved in performing inventive expertise and evidence based decision-making methods at block 180, such as Expertise And Evidence Based Decision-Making (EEDM) logic 182, baseline command sequences and frequencies 184, expert user profile, expert entered confidence level and supporting evidence 186, and scripts/models, decision points and recommendation values 188 used to embed expert knowledge and update a baseline command sequence. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

Communication Fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

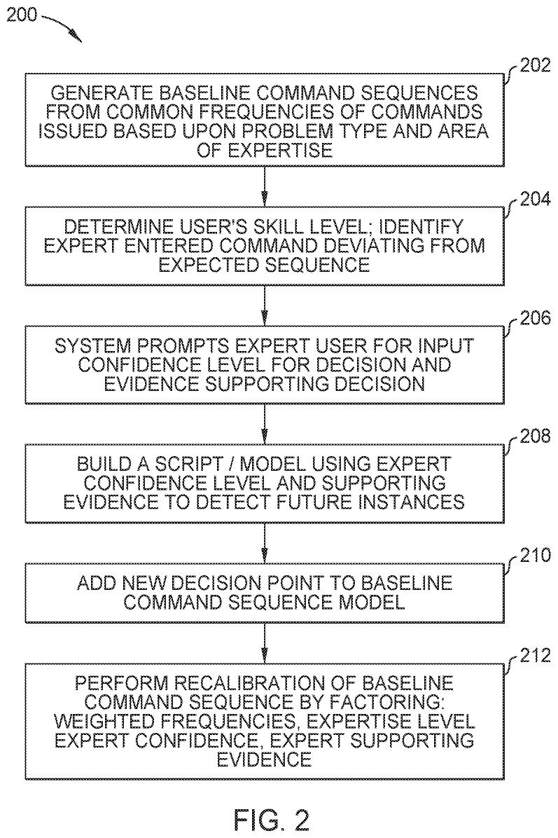

Referring to FIG. 2, there is shown a flow chart illustrating example operations of a computer-implemented method 200 of one or more embodiments of expertise and evidence based decision-making. Method 200 may be implemented with computer 101 for example, with operations of method 200 performed by EEDM logic 182 including generating and storing baseline command sequences and frequencies 184, expert user profiles, expert user entered confidence level and supporting evidence 186, and scripts/models, decision point and recommendation values 188. EEDM logic 182 enables updating and embedding expert user knowledge into a recommended baseline command sequence model using real time feedback from expert users.

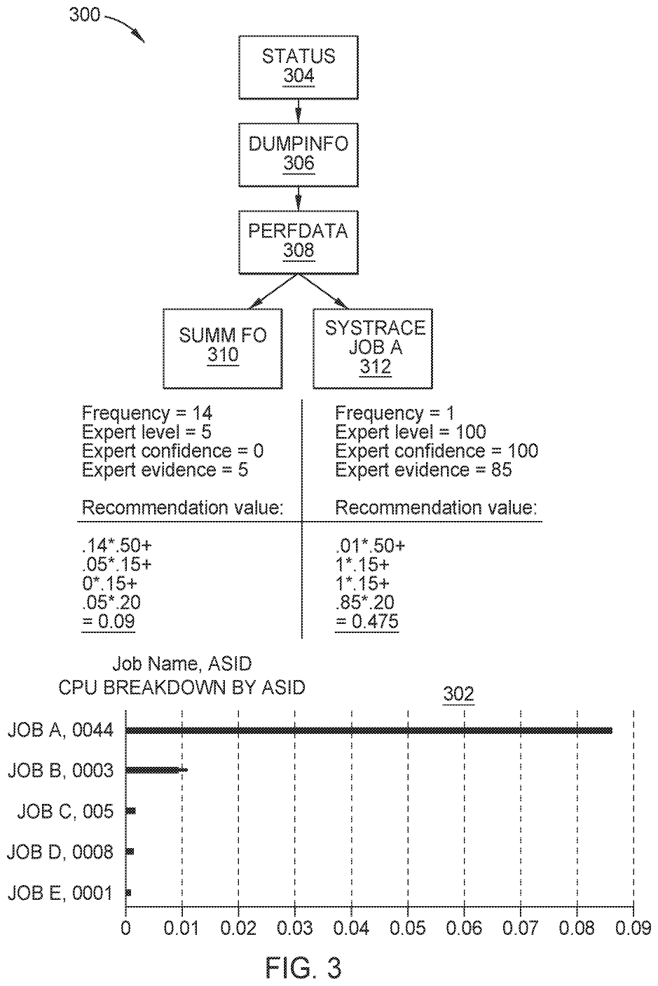

Referring also to FIG. 3, EEDM logic 182 can be implemented using an illustrated command tree 300. FIG. 3 illustrates a tree 300 of commands together with example expert user application data 302. The example application expert user data 302 illustrates CPU usage breakdown of an example server data dump for a job ASID including an expert user JOB A. Command Tree 300 includes blocks or command-line tools: STATUS 304, DUMPINFO 306, PERFDATA, 308, SUMM FO, 310, and SYSTRACE, JOB A. 312. As shown in FIG. 2, at a block 202, EEDM logic 182 generates baseline command sequences models for given tasks based upon command sequence that are most frequently used for a given problem or task. EEDM logic 182 generates the baseline command sequences from frequencies of commands issued by expert users and average users, based upon problem type and area of expertise for a given task.

At block 204, EEDM logic 182 identifies the expert user's skill level, and EEDM logic 182 monitors command sequences entered by an expert user. EEDM logic 182 identifies the user's skill lever, for example from user profiles including a variety of factors, such as number of cases solved, years of experience, and recommendations of others. The user's skill level can be manually entered and validated. The user's skill level varies based upon various application fields and contexts of a given task.

At block 204, EEDM logic 182 monitors command entered by expert users for a given task to identify a command entered by an expert user that diverges from the baseline command sequence model for a given task, i.e., a command that deviates from expected command sequence model. For example, blocks STATUS, 304, DUMPINFO 306, and PERFDATA, 308 of tree 300 can be used in identifying the deviating command at block 204, for example with DUMPINFO 306 providing data dump information for the deviating command, and PERFDATA, 308 providing performance data for the deviating command, such as shown for the example application 302.

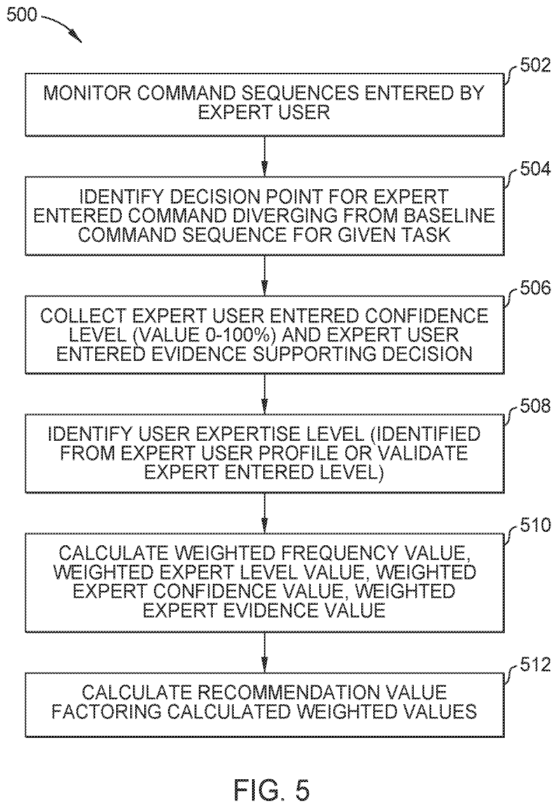

At block 206 EEDM logic 182 prompts the expert user for input of a confidence value and supporting evidence for the command that diverges from the baseline command sequence model, i.e., if the new command/sequence will be helpful, for example on a numerical scale between 0 and 100%. At block 206 EEDM logic 182 prompts the expert user to input supporting evidence for their command that diverges from the baseline command sequence model, such as evidence captured by the expert user that indicates why the expert user entered the diverging command. For example, the supporting evidence may be identified from data dump information for the command that diverges from the baseline command sequence model at block DUMPINFO 306 in FIG. 3. FIG. 5 further illustrates and describes operations performed at blocks 204 and 206 of method 200.

At block 208, the confidence level and supporting evidence entered by the expert is used to build a script/model that is added at this deviating command step into the baseline command sequence model to be detected by users in future instances of the baseline sequence model. At block 210, a new decision point is added for the deviating command into the baseline command sequence model for the given task, i.e., the new decision point is embedded into the baseline command sequence model at the point of the diverging command.

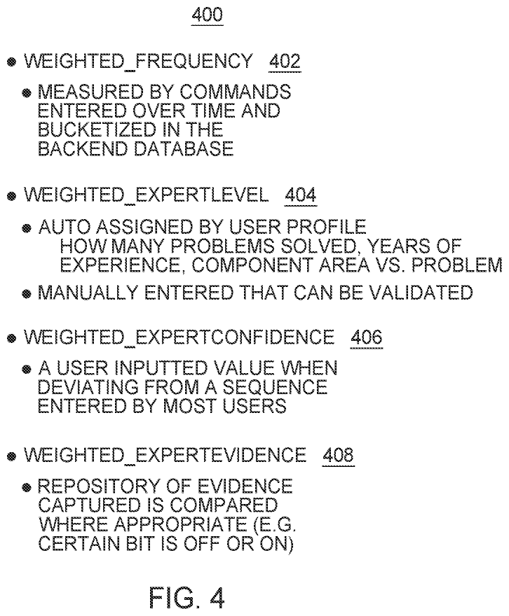

At block 210, EEDM logic 182 recalibrates of the baseline command sequence model to determine if the baseline command sequence model for the given task could be improved. SUMM FO, 310 for example provides frequencies of commands issued by expert users and average users that are used at block 212 to recalibrate and possibly update the baseline command sequence models generated at block 202 and SYSTRACE, JOB A, 312 records and reports selected expert user values for the expert user JOB A over a defined time period. EEDM logic 182 recalibrates the baseline command sequence model using weighted frequencies, expertise level expert confidence, and expert supporting evidence, such as shown in FIG. 4.

Referring also to FIG. 4, weighted components 400 are shown that are measured and used to identify a record or recommendation value. Identified recommendation values are used to selectively update a baseline command sequence model. Weighted_frequency 402 is measured by commands entered over time and bucketized in a backend database stored in baseline command sequences and frequencies 146 in system memory 106. Weighted_expertlevel 404 can be automatically assigned by a user profile, for example, including expert information of how many problems solved, years of experience, component area versus problem area. In addition, the weighted_expertlevel 404 can be manually entered and the manual entry can be validated. A weighted_expertconfidence 406 is a user-inputted value when user entered command deviating from a sequence entered by most users. The weighted user entered expert confidence 406 is a numerical value, for example in a range between 0 and 100, in response to a computer generated prompt, and factored to provide the weighted expert confidence 406. The weighted_expertevidence 408 is a user-inputted response providing supporting documentation or evidence for the command deviating from a baseline sequence. A repository of supporting evidence captured can be compared where available (e.g. indicated by certain bit that is off or on) to provide the weighted_expertevidence 408. Adding the values: weighted_frequency, weighted_expertlevel, weighted_expertconfidence, weighted_expertevidence values together can provide a numerical value representing the recommendation value.

Shown below command process tree 300 in FIG. 3 are example values of frequencies, expert level, expert confidence level and expert evidence values scaled with selected factors to provide weighted frequencies, weighted expert level, weighted expert confidence and weighted expert evidence. The weighted values are used to calculate an illustrated record or recommendation value. Example recommendation value are shown that are calculated using the example weighted frequencies, weighted expert level, weighted expert confidence and expert evidence.

At block 212, EEDM logic 182 recalibrates the baseline command sequence model using weighted frequencies 402, weighted expertise level 404, weighted expert confidence 406 and weighted expert evidence 408. In generating a new recommended baseline command sequence model with improved decision making capabilities, the weighted expert confidence and expert evidence are factored into a mathematical value used to create an updated baseline command sequence for future instances of the given task. The weighted frequencies and weighted expertise level also are factored into the mathematical value used to create the updated command sequence.

Referring now to FIG. 5, method 500 further illustrates and describes operations performed at blocks 204 and 206 of method 200 of FIG. 2. EEDM logic 182 at block 502 monitors issued commands of command sequences entered by an expert user for given tasks, such as using command block STATUS 304 in FIG. 3 . . . EEDM logic 182 identifies a decision point for a command entered by the expert user that diverges from a baseline command sequence model for a given task at block 504. EEDM logic 182, at block 506 collects an expert user entered confidence level value, and expert user entered evidence supporting the expert user's decision for the command that diverges from the baseline command sequence model. The supporting evidence may be found in data dump information that points to data corruption, such as identified using command blocks DUMPINFO 306 and PERFDATA 308 in FIG. 3. EEDM logic 182, at block 508 identifies an expert user's skill level or expertise level, such as from a user profile for the expert user identified at block 180 and stored with expert user profile, expert entered confidence level and supporting evidence 186. An expert user's expertise level may be identified from an expertise level entered by the expert user that can be validated. EEDM logic 182, at block 510 calculates weighted frequencies, weighted expertise level, weighted expert confidence and expert evidence, as illustrated described with respect to FIG. 4. EEDM logic 182, at block 512 calculates a recommendation value factoring the weighted expert confidence level and expert evidence. EEDM logic 182, at block 512 calculating the recommendation value also includes factoring weighted frequencies and weighted expertise level with the weighted expert confidence and expert evidence. The identified recommendation value is stored at block 188 and used to determine whether to update the baseline command sequence model for the given task. Depending on the identified recommendation value, for example less than a threshold value, the update baseline command sequence model for the given task may only include script with the added decision point without changing the commands in the baseline command sequence model,

While the foregoing is directed to embodiments of the present invention, other and further embodiments of the invention may be devised without departing from the basic scope thereof, and the scope thereof is determined by the claims that follow.

What is claimed is:

1. A computer-implemented method for expertise and evidence based decision making comprising:
differentiating between an average user and an expert user;
monitoring command sequences entered by the expert user for a given task;
identifying a command entered by the expert user that diverges from a baseline command sequence model for the given task;
prompting the expert user for input of a confidence level for the diverging command and for supporting evidence used by the expert user in entering the diverging command; and
recalibrating the baseline command sequence model for the given task based upon the confidence level and supporting evidence entered by expert user.

2. The method of claim 1, further comprising:
adding a decision point for the diverging command entered by the expert user into the baseline command sequence model for the given task.

3. The method of claim 1, wherein recalibrating the baseline command sequence model for the given task further comprises calculating a weighted confidence level and a weighted supporting evidence value by and factoring the expert confidence level and factoring the supporting evidence value.

4. The method of claim 3, wherein calculating a recommendation value further comprises identifying and factoring an expertise level of the expert user for the given task and identifying and factoring a frequency value of commands of the baseline command sequence model.

5. The method of claim 4, wherein identifying and factoring an expertise level of the expert user for the given task further comprises identifying and validating a user entered expertise level.

6. The method of claim 4, wherein identifying and factoring an expertise level of the expert user for the given task comprises using a user profile to identify the expertise level of the expert user.

7. The method of claim 4, wherein recalibrating the baseline command sequence model further comprises identifying a record value based upon a weighted value for said expert confidence, said supporting evidence, said expertise level, and said command sequence frequency.

8. The method of claim 7, wherein recalibrating the baseline command sequence model further comprises selectively updating the baseline command sequence model based upon the identified record value.

9. The method of claim 1, further comprises identifying most common tasks, and generating baseline command sequence models for the identified most common tasks.

10. The method of claim 9, measuring commands entered over time and storing command frequency for all users.

11. A system, comprising:
a processor; and
a memory, wherein the memory includes a computer program product configured to perform expertise and evidence based decision making, the operations comprising:
differentiating between an average user and an expert user;
monitoring command sequences entered by the expert user for a given task.
identifying a command entered by the expert user that diverges from a baseline command sequence model for the given task;
prompting the expert user for input of a confidence level for the diverging command and supporting evidence used by the expert user in entering the diverging command; and
recalibrating the baseline command sequence model for the given task based upon the expert user entered confidence level and supporting evidence.

12. The system of claim 11, wherein performing expertise and evidence based decision making further comprising:
using the recalibrated baseline command sequence model and updating the baseline command sequence model for the given task.

13. The system of claim 11, wherein performing expertise and evidence based decision making further comprising:
selectively updating the baseline command sequence model for the given task based upon identifying a weighted confidence level and identifying a weighted supporting evidence.

14. The system of claim 13, wherein recalibrating the baseline command sequence model further comprises identifying and factoring an expertise level of the expert user for the given task and identifying and factoring command frequency of the baseline command sequence model.

15. The system of claim 14, wherein recalibrating the baseline command sequence further comprises identifying a record value based upon a weighted value for said confidence level, said supporting evidence, said expertise level, and said command frequency, and selectively updating the baseline command sequence model based upon the identified record value.

16. A computer program product for expertise and evidence based decision making, the computer program product comprising:
a non-transitory computer-readable storage medium having computer-readable program code embodied therewith, the computer-readable program code executable by one or more computer processors to perform an operation comprising:
differentiating between an average user and an expert user; monitoring command sequences entered by the expert user for a given task;
identifying a command entered by the expert user that diverges from a baseline command sequence model for the given task;
prompting the expert user for input of a confidence level for the diverging command and supporting evidence used by the expert user in entering the diverging command; and recalibrating the baseline command sequence model for the given task based upon the expert user entered confidence level and supporting evidence.

17. The computer program product of claim 16, wherein the computer-readable program code is further executable to:
perform operations selectively updating the baseline command sequence model for the given task based upon factoring the expert user entered confidence level and the supporting evidence value.

18. The computer program product of claim 16, wherein recalibrating the baseline command sequence model further comprises identifying and factoring an expertise level of the expert user for the given task and identifying and factoring frequency of commands entered over time by all users of the baseline command sequence model.

19. The computer program product of claim 18, wherein recalibrating the baseline command sequence model further comprises identifying a record value by factoring a weighted value for each of said expert user entered confidence level, said supporting evidence, said expertise level, and said command frequency.

20. The computer program product of claim 19 wherein recalibrating the baseline command sequence model further comprises selectively updating the baseline command sequence model based upon the identified record value.
